(19) United States
(12) Patent Application Publication
(10) Pub. No.: US 2011/0276868 A1
(43) Pub. Date: Nov. 10, 2011

(54) Multi-Threaded Adjustment of Column Widths or Row Heights

(75) Inventors: Thomas J. Hoke, Sammamish, WA (US); Chad B. Rothschiller, Edmonds, WA (US); Su-Piao Wu, Sammamish, WA (US)

(73) Assignee: MICROSOFT CORPORATION, Redmond, WA (US)

(21) Appl. No.: 12/774,035

(22) Filed: May 5, 2010

(51) Int. Cl. G06F 17/00

(52) U.S. Cl. 715/217

(57) ABSTRACT

A computing system performs a column adjustment process. The column adjustment process uses multiple threads to determine overall maximum column widths for each column in a set of target columns in a spreadsheet table. For each of the target columns, the overall maximum column width for the target column is based on the width of the widest textual representation of a value in any cell in the column. The set of target columns includes at least one column. The computing system then reflows the spreadsheet table such that each column in the set of target columns has a width based on the overall maximum column width for the column. A similar process is performed to adjust the height of rows.

### BACKGROUND

Spreadsheet applications enable users to view and manipulate tabular data. For example, a spreadsheet application can enable a user to view and manipulate a table containing inventories of several products at several warehouses. When viewing a spreadsheet table, some users prefer to see the complete values in cells of the spreadsheet table. However, if the width of a column in a spreadsheet table is too narrow, the values in one or more cells in the column can be visually truncated. For example, a cell in a given column could contain a twenty character product name, but the given column is only wide enough for sixteen characters. Consequently, in this example, when there is a value in the cell next to this cell, the user would not be able to see four digits of the number.

To ensure that users can see the complete values in cells of a spreadsheet table, a spreadsheet application can perform a process to automatically adjust the widths of columns in the spreadsheet data. This process may require making a determination about the width of the text in each of the cells. When the number of cells in the spreadsheet table is large, the process of adjusting the widths of columns in the spreadsheet table can be relatively slow. Such delays can disrupt a user's train of thought or discourage the user from initiating the process to adjust the widths of columns in the spreadsheet table. Consequently, it is desirable to make the process of adjusting the widths of columns in a spreadsheet table as quick as possible.

### SUMMARY

A computing system performs a column adjustment process. The column adjustment process uses multiple threads to determine overall maximum column widths for columns in a spreadsheet table. For each of the columns, the overall maximum column width for the column is based on the width of the widest textual representation of any value in any cell in the column. The computing system then reflows the spreadsheet table such that the columns have widths based on the overall maximum column widths for the columns.

Similarly, a computing system performs a row adjustment process. The row adjustment process uses multiple threads to determine overall maximum row heights for rows in a spreadsheet table. The overall maximum row height for a row is based on the height of the highest textual representation of any value in any cell in the row. The computing system then reflows the spreadsheet table such that the rows have heights based on the overall maximum row heights for the rows.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example computing system.

FIG. 2 is a block diagram illustrating an example alternate embodiment of the computing system.

FIG. 3 is a flowchart illustrating an example operation of the spreadsheet application to adjust column widths.

FIG. 4 is a flowchart illustrating an example operation of a width evaluation thread.

FIG. 5 is a block diagram illustrating an example computing device.

### DETAILED DESCRIPTION

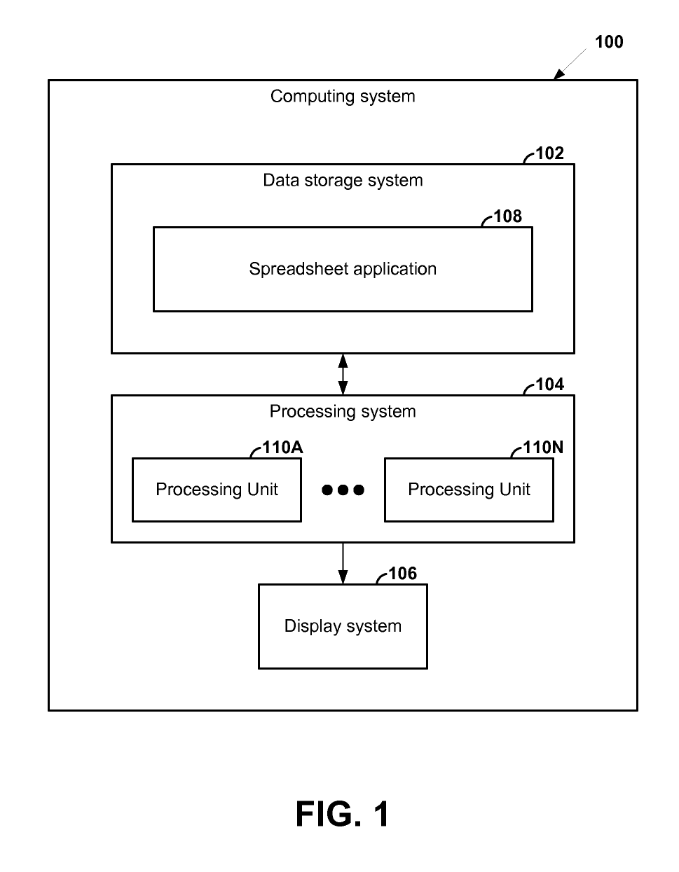

FIG. 1 is a block diagram illustrating an example computing system 100. The computing system 100 is a system comprising one or more computing devices. As used herein, a computing device is a physical, tangible device that processes information. In various embodiments, the computing system 100 comprises various types of computing devices. For example, the computing system 100 can comprise one or more desktop computers, laptop computers, netbook computers, handheld computing devices, smartphones, standalone server devices, blade server devices, mainframe computers, supercomputers, and/or other types of computing devices. In embodiments where the computing system 100 comprises more than one computing device, the computing devices in the computing system 100 can be distributed across various locations and communicate via a communications network, such as the Internet or a local area network.

As illustrated in the example of FIG. 1, the computing system 100 comprises a data storage system 102, a processing system 104, and a display system 106. It should be appreciated that in other embodiments, the computing system 100 includes more or fewer components than are illustrated in the example of FIG. 1. Moreover, it should be appreciated that FIG. 1 shows the computing system 100 in a simplified form for ease of comprehension.

The data storage system 102 is a system comprising one or more computer-readable data storage media. A computer-readable data storage medium is a physical device or article of manufacture that is capable of storing data in a volatile or non-volatile way. In some embodiments, the data storage system 102 comprises one or more computer-readable data storage media that are non-transient. Example types of computer-readable data storage media include random access memory (RAM), read-only memory (ROM), optical discs (e.g., CD-ROMs, DVDs, BluRay discs, HDDVD discs, etc.), magnetic disks (e.g., hard disk drives, floppy disks, etc.), solid state memory devices (e.g., flash memory drives), EEPROMS, field programmable gate arrays, and other types of non-transient devices and articles of manufacture. In some embodiments where the data storage system 102 comprises more than one computer-readable data storage medium, the computer-readable data storage media are distributed across various geographical locations.

The data storage system 102 stores computer-readable instructions representing a spreadsheet application 108. In some embodiments, the computer-readable instructions represent a version of the MICROSOFT® EXCEL® spreadsheet application or another spreadsheet application. In some embodiments where the data storage system 102 comprises more than one computer-readable data storage medium, the computer-readable instructions representing the spreadsheet application 108 are distributed across two or more of the computer-readable data storage media. In other embodiments where the data storage system 102 comprises more than one computer-readable data storage medium, the computer-readable instructions representing the spreadsheet application 108 are stored on only one of the computer-readable data storage media.

The processing system 104 is a system comprising a plurality of processing units 110A through 110N (collectively, “the processing units 110”). In various embodiments, the processing system 104 comprises various numbers of processing units. For example, the processing system 104 can comprise two, four, eight, sixteen, thirty-two, sixty-four, or other numbers of processing units. Each of the processing units 110 is a physical integrated circuit. Each of the processing units 110 is capable of executing computer-readable instructions asynchronously from the other ones of the processing units 110. As a result, the processing units 110 can independently execute computer-readable instructions in parallel with one another.

The display system 106 is a system used by the processing system 104 to display information to a user. In various embodiments, the display system 106 displays information to a user in various ways. For example, in some embodiments, the display system 106 comprises a graphics interface and a monitor.

The processing units 110 in the processing system 104 execute the computer-readable instructions that represent the spreadsheet application 108. The computer-readable instructions that represent the spreadsheet application 108, when executed by the processing units 110, cause the computing system 100 to provide the spreadsheet application 108. The spreadsheet application 108 enables a user to view and manipulate spreadsheet tables. Spreadsheet tables are tabular data sets organized into one or more rows and one or more columns. For example, a spreadsheet table can be a complete table in a spreadsheet, a portion of a table, a pivot table, or another type of spreadsheet table. A spreadsheet table can contain various types of data. For example, a spreadsheet table can contain sales data, inventory data, military data, billing data, statistical data, population data, demographic data, financial data, medical data, sports data, scientific data, or any other type of data that can be presented in a table.

Each cell in a spreadsheet table can have a value. The values in the cells can have various data types. For example, all cells in a particular column or a particular row can be integer numbers, real numbers, floating point numbers, alphanumeric text strings, dates, monetary amounts, Boolean values, and so on.

When a user is working with the spreadsheet application 108, the spreadsheet application 108 causes a graphical user interface to display a spreadsheet table to a user of the spreadsheet application 108 using the display system 106. In response to one or more different types of events, the spreadsheet application 108 performs a column adjustment process to determine the overall maximum columns widths for each column in a set of target columns in the spreadsheet table. The column adjustment process uses multiple width evaluation threads to determine the overall maximum columns widths for columns in some spreadsheet tables. The column adjustment process uses a single width evaluation thread to determine the overall maximum columns widths for columns in other spreadsheet tables. The overall maximum column width for a column is the width of a widest textual representation of any value in any cell in the column. The spreadsheet application 108 reflows the spreadsheet table such that each column in the set of target columns has a width based on the overall maximum column width for the column When the spreadsheet application 108 reflows the spreadsheet table, the spreadsheet application 108 causes the display system 106 to display the reflowed spreadsheet table.

The target columns are columns in the spreadsheet table on which the spreadsheet application 108 performs the column adjustment process. The set of target columns includes at least one column in the spreadsheet table. That is, the set of target columns can include a single column in the spreadsheet table or can include multiple columns in the spreadsheet table. Furthermore, in some instances, the set of target columns can include all of the columns in the spreadsheet table. Furthermore, in some embodiments, the user of the spreadsheet application 108 can select the columns in the set of target columns In other words, the spreadsheet application 108 receives one or more column selection inputs from a user. The column selection inputs indicate the target columns For example, a spreadsheet table includes columns “A” through “F.” In this example, the user provides one or more column selection inputs to the spreadsheet application 108 indicating that a column adjustment process should be performed on columns “A,” “C,” and “D.” In some embodiments, the set of target columns does not include columns whose widths were manually set by a user.

In various embodiments, the width of a column can be based on an overall maximum column width for the column in various ways. For example, in some embodiments, the width of a column is equal to the overall maximum column width for the column. In other embodiments, the width of a column is equal to the overall maximum column width for the column plus the width of a buffer. The buffer comprises spaces on either side of the values in cells that provide visual separation between values in cells of adjacent columns. The buffer can also include space needed to render control elements in the headers of the columns. Such control elements include, for example, autofilter dropdown buttons. The width of the buffer is typically small (e.g., less than five pixels on either size).

The following example illustrates an effect of the column adjustment process. In this example, a column in the spreadsheet table includes three cells. In this example, the first cell contains text that is 54 pixels wide, the second cell contains text that is 63 pixels wide, and the third cell contains text that is 34 pixels wide. In this example, the column is initially 50 pixels wide. The column adjustment process adjusts the width of the column such that the width of the column is 63 pixels wide, plus the buffer width. Hence, as a result of performing the column adjustment process, a user can see the complete value in the second cell.

The example in the previous paragraph describes a very simple spreadsheet table that only includes a single column with three cells. In many circumstances, real spreadsheet tables can include thousands of rows, thousands of columns, and millions of cells. As a result, sequentially evaluating the width of the text in each of the cells can be time and resource intensive. By using multiple width evaluation threads, the time required to perform the column adjustment process on a large spreadsheet table can be decreased proportional to the number of width evaluation threads.

Although most of the document discusses adjusting column widths and evaluating widths of text in cells, a row adjustment process can operate in a similar way to the described column adjustment process. The description in this document is applicable to the row adjustment process when discussion of columns is substituted for discussion of rows and discussion of widths is substituted for discussion of heights. The spreadsheet application 108 uses the row adjustment process to reflow a spreadsheet table such that each row in the spreadsheet table has a height based on an overall maximum row height for the row. The row adjustment process uses multiple height evaluation threads to determine the overall maximum row heights for each row in the spreadsheet table. The overall maximum row height for a row is the height of the highest text in any cell in the row.

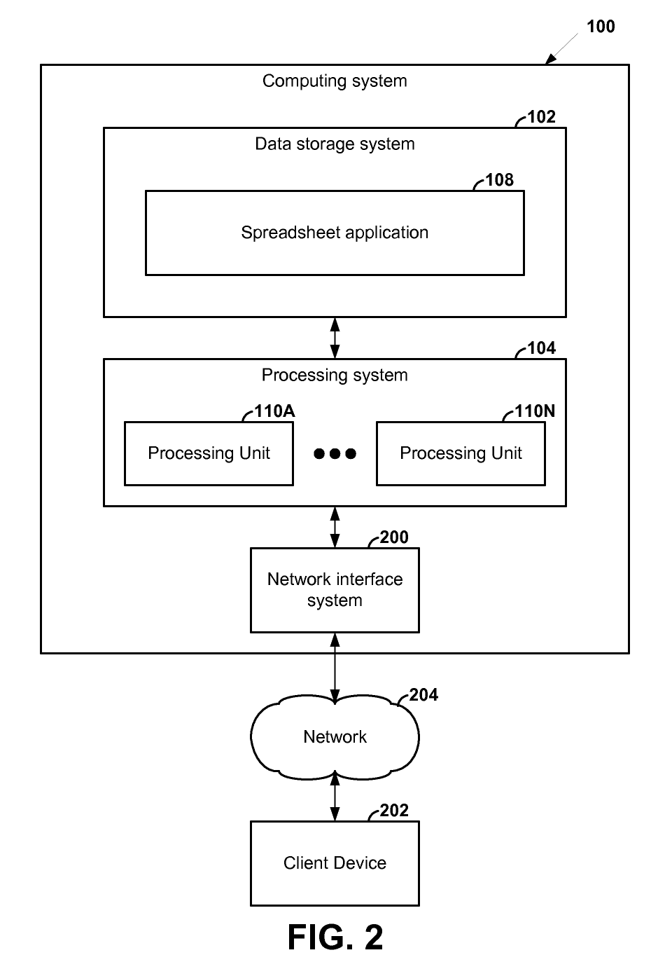

FIG. 2 is a block diagram illustrating an example alternate embodiment of the computing system 100. As illustrated in the example of FIG. 2, the computing system 100 comprises the data storage system 102 and the processing system 104, like in the example embodiment illustrated in FIG. 1. However, unlike the example embodiment illustrated in FIG. 1, the example alternate embodiment of the computing system 100 illustrated in FIG. 2, has a network interface 200 instead of the display system 106.

The network interface 200 enables the computing system 100 to send and receive data from a client device 202 via a network 204. The network 204 is a communications network comprising computing devices and links that facilitate communication among the computing system 100 and the client device 202. In various embodiments, the network 204 includes various types of computing devices. For example, the network 204 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 204 includes various types of links For example, the network 204 can include wired and/or wireless links. Furthermore, in various embodiments, the network 204 is implemented at various scales. For example, the network 204 can be implemented as one or more local area networks (LANs), metropolitan area networks, subnets, wide area networks (such as the Internet), or can be implemented at another scale.

The client device 202 is a computing device. For example, the client device 202 can be a personal computer used by a user. The user uses the client device 202 to send requests to the computing system 100 and receive data from the computing system 100 via the network 204. In this way, the user can use the client device 202 to view and manipulate tabular data using the spreadsheet application 108. For example, the computing system 100 can send data to the client device 202 via the network 204. In this example, the client device 202 is configured to process the data received from the spreadsheet application 108 for presentation to a user of the client device 202. For instance, the client device 202 can render a web page containing a spreadsheet table or interact with a client application to display a spreadsheet table.

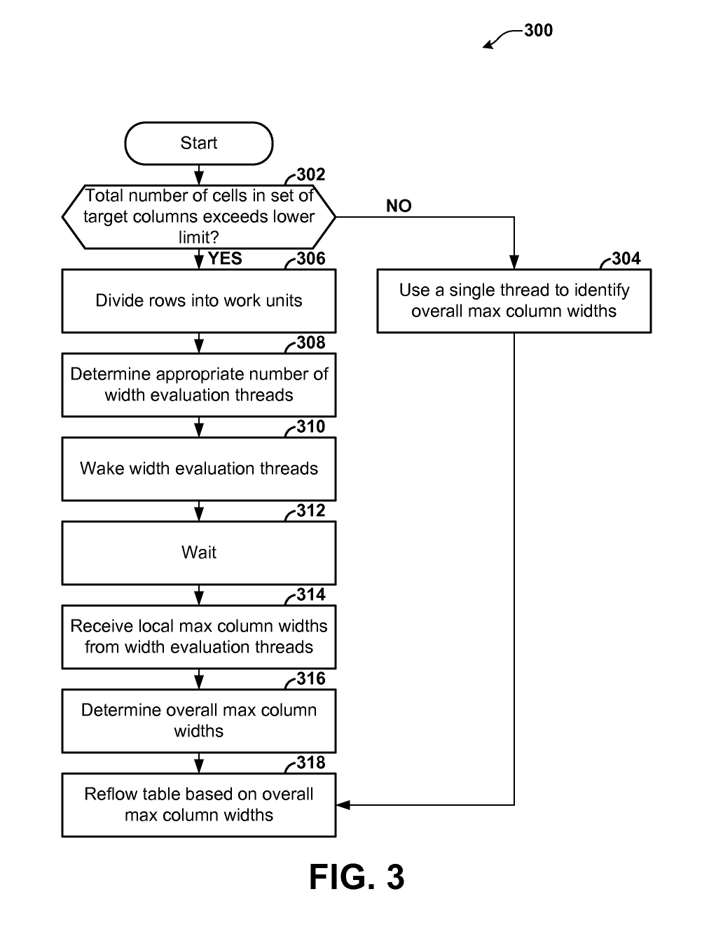

FIG. 3 is a flowchart illustrating an example operation 300 of the spreadsheet application 108 to adjust column widths. The spreadsheet application 108 can start the operation 300 in response to a variety of events. For example, in some embodiments, data in a spreadsheet table is derived from data in one or more external data sources. The external data sources can be relational databases, other spreadsheet tables, log files, XML files, directories, and/or other types of data sources. In this example, the spreadsheet application 108 starts the operation 300 when values in cells of the spreadsheet table are refreshed from the one or more external data sources. In another example, the spreadsheet table is a pivot table. The data in the pivot table is derived from one or more other spreadsheet tables. In this example, the spreadsheet application 108 starts the operation 300 when values in cells in the pivot table are refreshed from the one or more other spreadsheet tables. In yet another example, the spreadsheet application 108 starts the operation 300 when a user of the spreadsheet application 108 enters one or more values into cells of the spreadsheet table. In yet another example, the spreadsheet application 108 starts the operation 300 in response to receiving instructions from a user of the spreadsheet application 108 to perform the column adjustment process. In yet another example, the spreadsheet application 108 starts the operation 300 when a user of the spreadsheet application 108 reformats data in the spreadsheet table.

After starting, the spreadsheet application 108 determines whether the total number of cells in a set of target columns exceeds a lower limit (302). The set of target columns includes at least one of the columns of a spreadsheet table. In various embodiments, the set of target columns is determined in various ways. For example, in some embodiments, the spreadsheet application 108 receives column selection input from a user. The column selection input indicates the target columns. In another example, the spreadsheet application 108 automatically uses all of the columns in the spreadsheet table as the set of target columns. In yet another example, when the values of cells in the spreadsheet table are refreshed from an external data source, the set of target columns comprises the columns containing cells with refreshed values.

In various embodiments, the spreadsheet application 108 uses various lower limits. For example, in some embodiments, the lower limit is 2056 cells. In other embodiments, other lower limits are used (e.g., 1028 cells, 4112 cells, etc.).

If the total number of cells in the target columns does not exceed the lower limit (“NO” of 302), the spreadsheet application 108 uses a single width evaluation thread to identify the overall max column widths for each column in the set of target columns (304). The single width evaluation thread identifies the overall max column widths for each column in the set of target columns by calculating the width of the text in each cell in the target columns. In some embodiments, the single width evaluation thread is a thread of the spreadsheet application 108 performing the operation 300. In other embodiments, the single width evaluation thread is a thread different than the thread of the spreadsheet application 108 performing the operation 300.

If the total number of cells in the set of target columns exceeds the lower limit (“YES” of 302), the spreadsheet application 108 divides the rows of the spreadsheet table into a plurality of work units (306). In various embodiments, the work units include various numbers of rows. In some embodiments, each of the work units, aside from a possibly remainder work unit, contains the same number of rows. For instance, all work units, aside from the remainder work unit, can contain 256 rows. In such embodiments, the remainder work unit can contain fewer than 256 rows. For example, if the spreadsheet table comprises 1100 rows, there are four work units containing 256 rows and a remainder work unit containing 76 rows. In other embodiments, work units can contain rows that number more or less than 256. For example, in some embodiments, each of the work units contains 512 rows. Furthermore, in some embodiments, the spreadsheet application 108 presents a user interface that allows an administrative user to set the number of rows in the work units.

In addition, the spreadsheet application 108 determines an appropriate number of width evaluation threads (308). In various embodiments, the spreadsheet application 108 determines the appropriate number of width evaluation threads in various ways. For example, in some embodiments, the spreadsheet application 108 determines the appropriate number of width evaluation threads based on the number of work units and based on a number of processing units in the processing system 104. For instance, if the number of work units divided by four is less than or equal to the number of processing units 110 in the processing system 104, the spreadsheet application 108 determines that the appropriate number of width evaluation threads is the number of work units divided by four, rounded down. If the number of work units divided by four is greater than the number of processing units 110 in the processing system 104, the spreadsheet application 108 determines that the appropriate number of width evaluation threads is equal to the number of processing units 110 in the processing system 104.

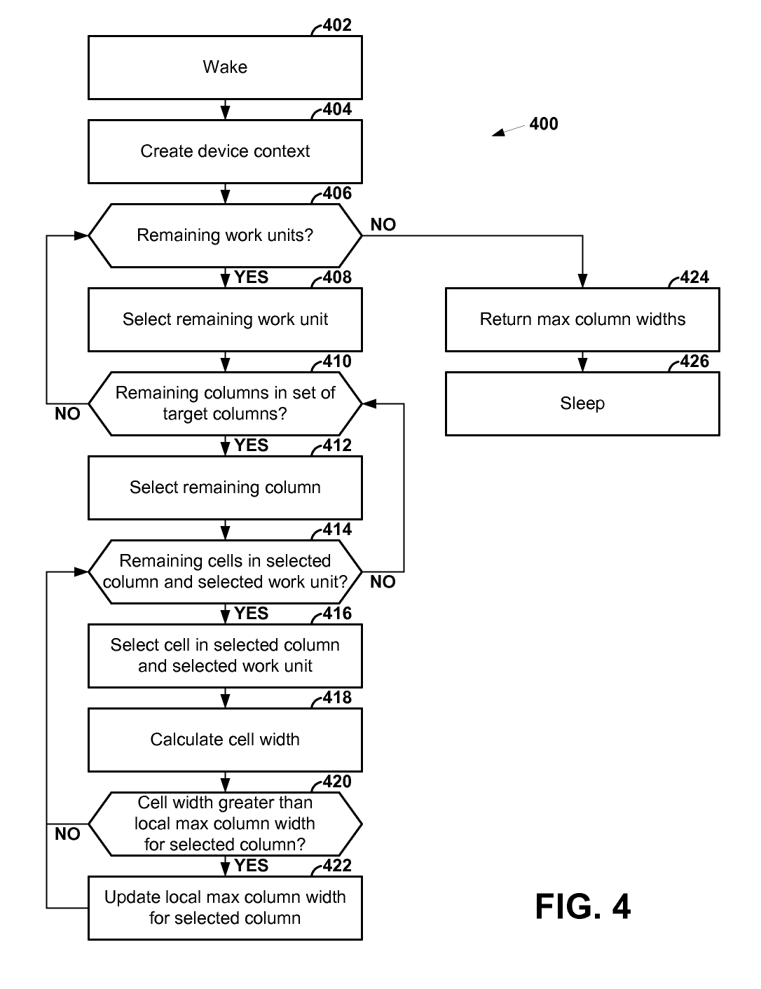

Next, the spreadsheet application 108 wakes a plurality of width evaluation threads (310). The number of width evaluation threads in the plurality of width evaluation threads is equal to the appropriate number of width evaluation threads. In various embodiments, the spreadsheet application 108 performs various actions to wake the plurality of width evaluation threads. For example, in some embodiments, the spreadsheet application 108 maintains a pool of sleeping threads that are available to act a width evaluation threads. In this example, the spreadsheet application 108 wakes threads in this pool of sleeping threads. In other embodiments, the spreadsheet application 108 instantiates and wake new threads to act as the width evaluation threads. An example operation performed by the width evaluation threads is illustrated with regard to FIG. 4.

After waking the width evaluation threads, the spreadsheet application 108 waits to receive local max columns widths from the width evaluation threads (312). In some embodiments, the spreadsheet application 108 can perform other actions while the spreadsheet application 108 is waiting to receive local max column widths from the width evaluation threads.

Subsequently, the spreadsheet application 108 receives local max column widths of the target columns from the width evaluation threads (314). The local max column widths are the widths of the widest text in cells of the target columns as determined by the width evaluation threads. The spreadsheet application 108 receives a local max column width of each column from each of the width evaluation threads. For example, if the spreadsheet table has three columns and there are two width evaluation threads, the spreadsheet application 108 receives three local max column widths from the first width evaluation thread and three local max column widths from the second width evaluation thread. Because the first width evaluation thread and the second width evaluation thread evaluate different rows in the spreadsheet table, the first width evaluation thread and the second width evaluation thread can return different local max column widths for the same column.

The spreadsheet application 108 then uses the local max column widths to determine the overall widest column widths for the target columns (316). In other words, for each column in the set of target columns, the spreadsheet application 108 identifies the overall maximum column width for the column by identifying a largest of the local maximum column widths for the column. For example, if there are two width evaluation threads and the spreadsheet application 108 receives a local max column width of fifty for a column from one width evaluation thread and receives a local max column width of sixty for the column from the another width evaluation thread, the spreadsheet application 108 determines that the overall widest column width for the column is sixty.

After identifying the overall max column widths for the target columns, the spreadsheet application 108 reflows the spreadsheet table such that each column in the set of target columns has a width based on the overall max column width for the column (318). In other words, the spreadsheet application 108 causes a graphical user interface to the display the spreadsheet table such that each column of the spreadsheet table has a width based on the overall max column width for that column. In various embodiments, the spreadsheet application 108 can cause the graphical user interface to display the reflowed spreadsheet table in various ways. For example, in some embodiments, the spreadsheet application 108 can send data to the client device 202. The client device 202 is configured to display the reflowed spreadsheet table. In another example, the spreadsheet application 108 can, in some embodiments, use the display system 106 to display the reflowed spreadsheet table.

FIG. 4 is a flowchart illustrating an example operation 400 of a width evaluation thread. The operation 400 begins when the width evaluation thread is woken by the spreadsheet application 108 (402). When the spreadsheet application 108 wakes the width evaluation thread, the spreadsheet application 108 provides a reference to the set of target columns and the pool of work units. The width evaluation thread can perform a variety of actions when the width evaluation thread wakes. For example, in some embodiments, the width evaluation thread initializes a set of max column widths. The set of max column widths includes a max column width for each column in the set of target columns. Initially, each of the max column widths is equal to zero.

After waking, the spreadsheet application 108 creates a device context (404). A device context is a data structure used to define attributes of text and images that are output to a screen or printer. A device context contains various attributes. For example, a device context can contain attributes that specify a default font for the window, a default font size for the window, context of the window, and so on.

The width evaluation thread then determines whether there are any available work units in the pool of work units (406). A work unit is an available work unit when no width evaluation thread is currently calculating the maximum column widths of the work unit and no width evaluation thread has previous calculated the maximum column widths of the work unit during the present column adjustment process. In various embodiments, the width evaluation thread determines whether there are available work units in various ways. For example, in some embodiments, the spreadsheet application 108 maintains a data structure that contains a flag corresponding to each work unit. A flag corresponding to a particular work unit has one value when the particular work unit is available and another value when the particular work unit is not available. In another example, the spreadsheet application 108 generates a stack data structure containing references to work units. If the stack data structure is empty, there are no available work units in the pool of work units.

If there are one or more remaining work units (“YES” of 406), the width evaluation thread selects one of the work units from the pool of available work units (408). Each of the width evaluation threads participating in the column adjustment process selects work units from the same pool of available work units. For example, a width evaluation thread “A” and a width evaluation thread “B” are participating in the column adjustment process and the pool of available work units includes work units “X,” “Y,” and “Z.” In this example, both the width evaluation thread “A” and the width evaluation thread “B” select available work units from among the work units “X,” “Y,” and “Z.”

When the width evaluation thread selects one of the available work units, the width evaluation thread locks the selected work unit such that none of the other width evaluation threads can select the work unit selected by the width evaluation thread. In various embodiments, the width evaluation thread selects an available work unit in various ways. For example, in some embodiments, the width evaluation thread selects one of the available work units on a pseudorandom basis. In other embodiments, the width evaluation thread selects one of the available work units based on an order assigned to the work units. In yet other embodiments, the width evaluation thread pops a top reference off a stack data structure containing references to available work units. The work unit referred to by the reference popped off the stack data structure is the selected work unit.

The width evaluation thread then determines whether there are any remaining columns in the set of target columns (410). In various embodiments, the width evaluation thread determines whether there are any remaining columns in the set of target columns in various ways. For example, in some embodiments, the width evaluation thread generates a stack data structure containing a reference to each of the target columns. If there stack data structure is not empty, the width evaluation thread determines that there are remaining columns in the set of target columns. In other embodiments, the width evaluation thread maintains a data structure containing flags corresponding to each of the target columns A flag has one value when the column has been evaluated and another value when the column has not been evaluated. The width evaluation thread uses these flags to determine whether columns are remaining.

If there are one or more remaining columns in the set of target columns (“YES” of 410), the width evaluation thread selects one of the remaining columns in the set of target columns (412). In various embodiments, the width evaluation thread selects one of the remaining columns in various ways. For example, in some embodiments, the width evaluation thread pops a reference to the selected column from a stack data structure that initially contained a reference to each of the target columns. In other embodiments, the width evaluation thread selects the rightmost remaining column in the set of target columns. In yet other embodiments, the width evaluation thread selects remaining columns on another basis.

The width evaluation thread then determines whether there are any remaining cells that are in the selected column and in the selected work unit (414). In various embodiments, the width evaluation thread determines whether there are any remaining cells that are in the selected column and the selected work unit in various ways. For example, in some embodiments, the width evaluation thread maintains a row index. The row index indicates a row in the selected work unit. When the width evaluation thread selects the selected column, the row index indicates a row having a lowest row number in the selected work unit. In this example, if the row index indicates a row having a row number above the highest row number in the selected work unit, the width evaluation thread determines that there are no remaining cells in the selected column.

If there are one or more remaining cells that are in the selected column and the selected work unit (414), the width evaluation thread selects one of the remaining cells that is in the selected column and the selected work unit (416). In various embodiments, the width evaluation thread selects one of the remaining cells in selected column and selected work unit in various ways. For example, in some embodiments, the width evaluation thread maintains a row index as described above. In this example, the width evaluation thread selects a cell in the row indicated by the row index. The width evaluation thread then increments the row index.

After selecting the cell, the width evaluation thread calculates a cell width for the selected cell (418). In various embodiments, the width evaluation thread calculates a cell width for the selected cell in various ways. For example, in some embodiments, the width evaluation thread invokes a text extent method of a graphics application programming interface (API). When the width evaluation thread invokes the text extent method, the width evaluation thread provides the text in the selected cell and the device context created by the width evaluation thread to the text extent method. The text extent method then uses attributes of the device context to determine a width of the text in the selected cell. The text extent method returns the width of the text in the selected cell to the width evaluation thread. In some embodiments, the text extent method is part of the Graphics Device Interface (GDI) API or GDI+API of the MICROSOFT® WINDOWS® operating system. While the text extent method is determining the width of the selected cell, the text extent method locks the device context such that no other process or width evaluation thread can read or write to the device context. If all of the width evaluation threads were trying to provide the same device context to the text extent method, the width evaluation threads would have to wait for other width evaluation threads to finish using the device context. To reduce this contention for the device context, each of the width evaluation threads creates a separate device context.

After calculating the cell width for the selected cell, the width evaluation thread determines whether the cell width for the selected cell is greater than the local max column width for the selected column (420). If the cell width for the selected cell is greater than the local max column width for the selected column (“YES” of 420), the width evaluation thread updates the local max column width for the selected column (422). For example, if the local max column width for the selected column is thirty pixels and the cell width of the selected cell is forty pixels, the width evaluation thread updates the local max column width for the selected column such that the local max column width for the selected column is forty pixels. However, if the local max column width for the selected column is thirty pixels and the cell width for the selected cell is twenty pixels, the width evaluation thread does not update the local max column width.

After updating the local max column width for the selected column or after determining that the cell width for the selected cell is not greater than the local max column width for the selected column (“NO” of 420), the width evaluation thread again determines whether there are remaining cells that are in the selected column and in the selected work unit (414). If there are one or more remaining cells that are in the selected column and the selected work unit, the width evaluation thread repeats steps 416, 418, 420, and possibly step 422 with regard to another remaining cell in the selected column.

If, however, there are no remaining cells that are in the selected column and in the selected work unit (“NO” of 414), the width evaluation thread again determines whether there are any remaining columns in the set of target columns (410). If there are one or more remaining columns in the set of target columns, the width evaluation thread repeats step 412 and possibly steps 414, 416, 418, 420, and 422 with regard to another remaining column in the set of target columns.

If there are no remaining columns in the selected work unit (“NO” of 410), the width evaluation thread again determines whether there are any remaining work units (406). If there are one or more remaining work units, the width evaluation thread repeats step 408 and possibly steps 410, 412, 414, 416, 418, 420, and 422 with regard to another remaining work unit.

If there are no remaining work units (“NO” of 406), the width evaluation thread provides the local max column widths to the spreadsheet application 108 (424). After providing the local max column widths to the spreadsheet application 108, the width evaluation thread sleeps (426).

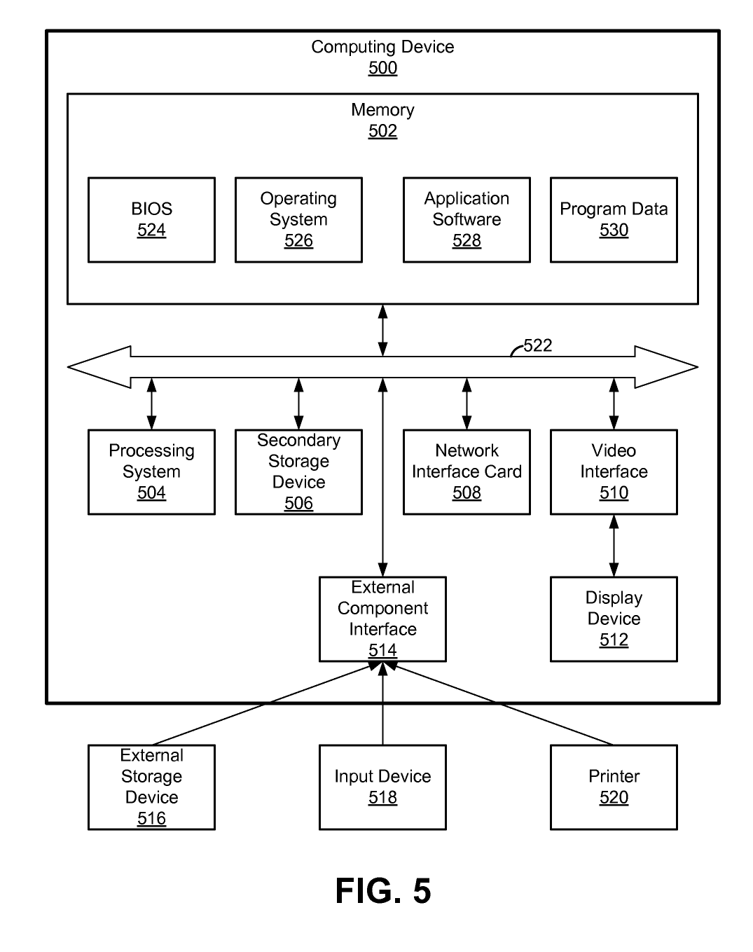

FIG. 5 is a block diagram illustrating an example computing device 500. In some embodiments, the computing system 100 is implemented using one or more computing devices like the computing device 500. It should be appreciated that in other embodiments, the computing system 100 is implemented using computing devices having hardware components other than those illustrated in the example of FIG. 5.

In different embodiments, computing devices are implemented in different ways. For instance, in the example of FIG. 5, the computing device 500 comprises a memory 502, a processing system 504, a secondary storage device 506, a network interface card 508, a video interface 510, a display device 512, an external component interface 514, an external storage device 516, an input device 518, a printer 520, and a communication medium 522. In other embodiments, computing devices are implemented using more or fewer hardware components. For instance, in another example embodiment, a computing device does not include a video interface, a display device, an external storage device, or an input device.

The memory 502 includes one or more computer-readable data storage media capable of storing data and/or instructions. As used in this document, a computer-readable data storage medium is a device or article of manufacture that stores data and/or software instructions readable by a computing device. In different embodiments, the memory 502 is implemented in different ways. For instance, in various embodiments, the memory 502 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system 504 includes one or more physical integrated circuits that selectively execute software instructions. In various embodiments, the processing system 504 is implemented in various ways. For instance, in one example embodiment, the processing system 504 is implemented as one or more processing cores. For instance, in this example embodiment, the processing system 504 may be implemented as one or more Intel Core 2 microprocessors. In another example embodiment, the processing system 504 is implemented as one or more separate microprocessors. In yet another example embodiment, the processing system 504 is implemented as an ASIC that provides specific functionality. In yet another example embodiment, the processing system 504 provides specific functionality by using an ASIC and by executing software instructions.

In different embodiments, the processing system 504 executes software instructions in different instruction sets. For instance, in various embodiments, the processing system 504 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 506 includes one or more computer-readable data storage media. The secondary storage device 506 stores data and software instructions not directly accessible by the processing system 504. In other words, the processing system 504 performs an I/O operation to retrieve data and/or software instructions from the secondary storage device 506. In various embodiments, the secondary storage device 506 is implemented by various types of computer-readable data storage media. For instance, the secondary storage device 506 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 508 enables the computing device 500 to send data to and receive data from a computer communication network. In different embodiments, the network interface card 508 is implemented in different ways. For example, in various embodiments, the network interface card 508 is implemented as an Ethernet interface, a token-ring network interface, a fiber optic network interface, a wireless network interface (e.g., WiFi, WiMax, etc.), or another type of network interface.

The video interface 510 enables the computing device 500 to output video information to the display device 512. In different embodiments, the video interface 510 is implemented in different ways. For instance, in one example embodiment, the video interface 510 is integrated into a motherboard of the computing device 500. In another example embodiment, the video interface 510 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 512 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 510 communicates with the display device 512 in various ways. For instance, in various embodiments, the video interface 510 communicates with the display device 512 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 514 enables the computing device 500 to communicate with external devices. In various embodiments, the external component interface 514 is implemented in different ways. For instance, in one example embodiment, the external component interface 514 is a USB interface. In other example embodiments, the computing device 500 is a FireWire interface, a serial port interface, a parallel port interface, a PS/2 interface, and/or another type of interface that enables the computing device 500 to communicate with external components.

In different embodiments, the external component interface 514 enables the computing device 500 to communicate with different external components. For instance, in the example of FIG. 5, the external component interface 514 enables the computing device 500 to communicate with the external storage device 516, the input device 518, and the printer 520. In other embodiments, the external component interface 514 enables the computing device 500 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 500.

The external storage device 516 is an external component comprising one or more computer readable data storage media. Different implementations of the computing device 500 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 518 is an external component that provides user input to the computing device 500. Different implementations of the computing device 500 interface with different types of input devices. Example types of input devices include, but are not limited to, keyboards, mice, trackballs, stylus input devices, key pads, microphones, joysticks, touch-sensitive display screens, and other types of devices that provide user input to the computing device 500. The printer 520 is an external device that prints data to paper. Different implementations of the computing device 500 interface with different types of printers. Example types of printers include, but are not limited to laser printers, ink jet printers, photo printers, copy machines, fax machines, receipt printers, dot matrix printers, or other types of devices that print data to paper.

The communications medium 522 facilitates communication among the hardware components of the computing device 500. In different embodiments, the communications medium 522 facilitates communication among different components of the computing device 500. For instance, in the example of FIG. 5, the communications medium 522 facilitates communication among the memory 502, the processing system 504, the secondary storage device 506, the network interface card 508, the video interface 510, and the external component interface 514. In different implementations of the computing device 500, the communications medium 522 is implemented in different ways. For instance, in different implementations of the computing device 500, the communications medium 522 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 502 stores various types of data and/or software instructions. For instance, in the example of FIG. 5, the memory 502 stores a Basic Input/Output System (BIOS) 524, an operating system 526, application software 528, and program data 530. The BIOS 524 includes a set of software instructions that, when executed by the processing system 504, cause the computing device 500 to boot up. The operating system 526 includes a set of software instructions that, when executed by the processing system 504, cause the computing device 500 to provide an operating system that coordinates the activities and sharing of resources of the computing device 500. Example types of operating systems include, but are not limited to, Microsoft Windows®, Linux, Unix, Apple OS X, Apple OS X iPhone, Palm webOS, Palm OS, Google Chrome OS, Google Android OS, and so on. The application software 528 includes a set of software instructions that, when executed by the processing system 504, cause the computing device 500 to provide applications to a user of the computing device 500. The program data 530 is data generated and/or used by the application software 528.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

We claim:

1. A method comprising:
performing, by a computing system, a column adjustment process that uses multiple threads to determine overall maximum column widths for each column in a set of target columns in a spreadsheet table, the set of target columns including at least one column; and
reflowing the spreadsheet table such that each column in the set of target columns has a width based on the overall maximum column width for the column.

2. The method of claim 1, wherein performing the column adjustment process comprises:
dividing rows in the spreadsheet table into a plurality of work units, each of the width evaluation threads selecting one or more work units from the plurality of work units and determining local maximum columns widths for each column in the one or more selected work units; and
identifying, for each column in the set of target columns, the overall maximum column width by identifying a largest of the local maximum column widths for the column.

3. The method of claim 2, wherein each of the work units, aside from possibly a remainder work unit, contains the same number of rows.

4. The method of claim 2,
wherein performing the column adjustment process comprises: determining an appropriate number of width evaluation threads based on the number of work units in the plurality of work units and based on a number of processing units in a processing system;
wherein the number of width evaluation threads is equal to the appropriate number of width evaluation threads.

5. The method of claim 1,
wherein prior to performing the column adjustment process, the threads are sleeping; and
wherein performing the column adjustment process comprises waking the threads.

6. The method of claim 1, wherein performing the column adjustment process comprises:
determining whether a number of cells in the set of target columns exceeds a lower limit; and
using a single thread to determine the overall maximum column widths when the number of cells in the set of target columns does not exceed the lower limit.

7. The method of claim 1,
wherein each of the width evaluation threads creates a device context; and
wherein each of the width evaluation threads uses the device context created by the width evaluation thread to evaluate widths of text in cells in the set of target columns.

8. The method of claim 1,
wherein values in cells of the spreadsheet table are derived from data in one or more external data sources; and
wherein the method further comprising: starting the column adjustment process when the values in the cells of the spreadsheet table are refreshed from the one or more external data sources.

9. The method of claim 1, wherein reflowing the spreadsheet table comprises: transmitting data to a client device via a network, the client device configured to use the data to display the spreadsheet table.

10. The method of claim 1, wherein reflowing the spreadsheet table comprises: using a display system to display the spreadsheet table to a user of the computing system.

11. The method of claim 1, further comprising: receiving, by the computing system, one or more column selection inputs from a user, the one or more column selection inputs indicating the columns in the set of target columns.

12. A computing system comprising:
a processing system comprising one or more processing units; and
a data storage system storing computer-readable instructions that represent a spreadsheet application, the computer-readable instructions, when executed by the one or more processing units, cause the computing system to provide the spreadsheet application, the spreadsheet application configured to:
perform a row adjustment process that uses multiple threads to determine overall maximum row heights for each row in a set of target rows in a spreadsheet table when the number of cells in the set of target rows exceeds a lower limit, the set of target rows including at least one row; and
reflow the spreadsheet table such that each row in the set of target rows has a height based on the overall maximum row height for the row.

13. The computing system of claim 12, wherein the spreadsheet application performs the following as part of the row adjustment process:
divide columns in the spreadsheet table into a plurality of work units, each of the height evaluation threads selecting one or more work units from the plurality of work units and determining local maximum row heights for each row in the one or more selected work units, wherein each of the work units, aside from a possibly remainder work unit, contains the same number of columns; and
identify, for each row in the set of target rows, the overall maximum row heights by identifying a largest of the local maximum row heights for the row.

14. The computing system of claim 13, wherein the spreadsheet application performs the following as part of the row adjustment process:
determine an appropriate number of height evaluation threads based on the number of work units in the plurality of work units and based on a number of the processing units in the processing system;
wherein the number of height evaluation threads is equal to the appropriate number of height evaluation threads.

15. The computing system of claim 13, wherein the spreadsheet application performs the following as part of the row adjustment process:
determine whether a number of cells in the set of target rows exceeds a lower limit; and
using a single thread to determine the overall maximum row heights when the number of cells in the set of target rows does not exceed the lower limit.

16. The computing system of claim 13, wherein each of the height evaluation threads creates a device context and uses the device context to evaluate heights of text in cells in the set of target rows.

17. The computing system of claim 13, wherein the spreadsheet application starts the row adjustment process in response to an input from a user of the computing system.

18. The computing system of claim 13, wherein the spreadsheet application uses a display system to display the spreadsheet table to a user of the spreadsheet application.

19. The computing system of claim 13, wherein the set of target rows includes some, but not all, of the rows in the spreadsheet table.

20. A computer-readable data storage medium that stores computer-readable instructions that, when executed by one or more processing units in a processing system of a computing system, cause the computing system to provide a spreadsheet application configured to:
cause a graphical user interface to display a spreadsheet table;
receive one or more column selection inputs from a user of the spreadsheet application, the one or more column selection inputs indicating a set of target columns in the spreadsheet table, the set of target columns including one or more columns in the spreadsheet table;
determine whether a number of cells in the set of target columns exceeds a lower limit;
use a single thread to determine overall maximum columns widths for the target columns when the number of cells in the set of target columns does not exceed the lower limit;
perform the following actions when the number of cells in the set of target columns exceeds the lower limit:
divide rows in the spreadsheet table into a plurality of work units, each of the work units, aside from possibly a remainder work unit, containing the same number of rows;
determine an appropriate number of width evaluation threads based on the number of work units in the plurality of work units and based on the number of the processing units in the processing system;
wake a plurality of width evaluation threads, the number of width evaluation threads in the plurality of width evaluation threads being equal to the appropriate number of width evaluation threads, each width evaluation thread in the plurality of width evaluation threads performing the following actions until there are no remaining work units in the plurality of work units:
create a device context;
select one or more work units in the plurality of work units;
use one of the device context to calculate widths of text in cells in the one or more selected work units;
use the widths of text in the cells in the one or more selected work units to determine local maximum column widths of each column in the set of target columns; and
use the local maximum columns widths determined by the width evaluation threads to determine the overall maximum columns widths for the set of target columns;
reflow the spreadsheet table such that each column in the set of target columns has a width based on the overall maximum column width for the column, thereby causing the spreadsheet table to be displayed to a user of the spreadsheet application.
